(19) United States
(12) Patent Application Publication
(10) Pub. No.: US 2026/0287211 A1
(43) Pub. Date: Sep. 24, 2026

(54) SOLAR MODULE SLIDE-IN FRAME DESIGN

(71) Applicant: Nextpower LLC, Fremont, CA (US)

(72) Inventor: Craig Bradley Edward Wildman, Kensington, CA (US)

(21) Appl. No.: 19/536,300

(22) Filed: Feb. 11, 2026

Related U.S. Application Data
(60) Provisional application No. 63/775,492, filed on Mar. 21, 2025.

(51) Int. Cl. F24S 25/70; F24S 25/12; F24S 25/65

(52) U.S. Cl. CPC F24S 25/70; F24S 25/12; F24S 25/65

(57) ABSTRACT

Systems and methods for mounting one or more solar modules to a torque tube including a module support rail having a lower portion couplable to a torque tube and an upper portion including a first end portion including a first tab and a second end portion defining a first hole configured to accept a first fastener. A first solar module coupled with a first solar module frame, the first solar module frame defining a first tab slot configured to accept the first tab to couple the first solar module frame to the module support rail. A first hole spaced apart from the first tab slot along a length of the first solar module frame, the first hole configured to align with the first hole of the module support rail and accept the first fastener to further couple the first solar module frame to the module support rail.

### CROSS-REFERENCE TO RELATED APPLICATIONS

This application claims the benefit of U.S. Provisional Patent Application No. 63/775,492, filed Mar. 21, 2025. The entire contents of each of these applications are incorporated herein by reference.

### TECHNICAL FIELD

This disclosure relates generally to solar tracker systems, and more particularly to systems and methods of providing frames for solar modules within solar tracker systems designed for simplified install.

### BACKGROUND

Solar cells and solar panels are most efficient in sunny conditions when oriented towards the sun at a certain angle. Many solar panel systems are designed in combination with solar trackers, which follow the sun's trajectory across the sky from east to west to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds of individual solar modules that are mechanically coupled to support structures.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Typical solar trackers require the use of at least four fasteners to secure the solar module to the rails. Thus furthers the manual labor required to install solar modules. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application. The present disclosure seeks to address the shortcomings of prior tracker systems.

### SUMMARY

In general, the present disclosure relates generally to solar tracker systems, and more particularly to systems and methods of providing frames for solar modules within solar tracker systems designed for simplified install. In one example, a mounting system for mounting one or more solar modules to a torque tube may include a module support rail having a lower portion couplable to a torque tube and an upper portion, the upper portion of the module support rail may include a first end portion including a first tab, a second end portion defining a first hole configured to accept a first fastener, and a first solar module coupled with a first solar module frame. The first solar module frame may define a first tab slot sized and shaped to accept the first tab to couple the first solar module frame to the module support rail, and a first hole spaced apart from the first tab slot along a length of the first solar module frame, the first hole of the first solar module frame configured to align with the first hole of the module support rail and to accept the first fastener to further couple the first solar module frame to the module support rail.

Additionally or alternatively, a slot reinforcement plate may be coupled to the first solar module frame proximate the first tab slot.

Additionally or alternatively, the slot reinforcement plate may define a third tab slot, the third tab slot approximately the same size and shape of the first tab slot.

Additionally or alternatively, the module support rail may include a tab reinforcement plate coupled with the first tab.

Additionally or alternatively, the tab reinforcement plate may be integrated with the first tab into a singular component.

Additionally or alternatively, the first tab slot may include a thin slot section and a deep slot section, the thin slot section sized and shaped to lock the first solar module frame to the module support rail in a position.

Additionally or alternatively, a height of the thin slot section may be less than a height of the deep slot section but greater than a thickness of the first tab.

Additionally or alternatively, the first tab may have a first tab width, and the first tab slot may include a deep slot section defined by the first solar module frame, the deep slot section having a slot width sufficiently larger than the first tab width to enable the first tab to be inserted into the first tab slot.

Additionally or alternatively, the first tab may include one or more bends, the one or more bends of the first tab configured to prevent the first tab from decoupling from the first tab slot of the first solar module frame.

Additionally or alternatively, the one or more bends may include a bend of around 90 degrees.

Additionally or alternatively, the first end portion of the module support rail may further include a second tab, and the second end portion of the module support rail may further define a second hole configured to accept a second fastener.

Additionally or alternatively, a second solar module may be coupled with a second solar module frame. The second solar module frame may include a second tab slot sized and shaped to accept the second tab to couple the second solar module frame to the module support rail, and a second hole spaced apart from the second tab slot along a length of the second solar module frame, the second hole of the second solar module frame configured align with the second hole of the module support rail and to accept the second fastener to further couple the second solar module frame to the module support rail.

In another example, a mounting system for mounting a solar module to a torque tube, the mounting system may include a first module support rail couplable to a torque tube. The first module support rail may include a first end portion including a first tab, a second end portion defining a first hole configured to accept a first fastener. A second module support rail couplable to the torque tube may include a first end portion including a second tab, a second end portion defining a second hole configured to accept a second fastener, and a solar module coupled with a solar module frame. The solar module frame may include a first tab slot sized and shaped to accept the first tab on a first side of the solar module frame, a second tab slot sized and shaped to accept the second tab on a second side of the solar module frame, a first hole spaced apart from the first tab slot along a length of the first side of the solar module frame, the first hole of the solar module frame configured align with the first hole of the first module support rail and to accept the first fastener to couple the solar module frame to the first module support rail, and a second hole spaced apart from the second tab slot along a length of the second side of the solar module frame, the second hole of the solar module frame configured align with the second hole of the second module support rail and to accept the second fastener to couple the solar module frame to the second module support rail.

Additionally or alternatively, the solar module frame may have an approximately consistent thickness on its first side and its second side.

Additionally or alternatively, a first tab slot reinforcement plate may be secured proximate the first tab slot and a second tab slot reinforcement plate may be secured proximate the second tab slot, the first tab slot reinforcement plate and the second tab slot reinforcement plate increasing an overall thickness between an interior surface and an exterior surface of the solar module frame at the respective tab slot.

Additionally or alternatively, the first tab slot reinforcement plate and the second tab slot reinforcement plate may have thicknesses greater than the thickness of the solar module frame.

Additionally or alternatively, a thickness of the solar module frame may be in the range of about 1.2 millimeters to 1.5 millimeters.

In another example, a method of mounting a solar module to a torque tube may include providing a first module support rail, the first module support rail including a first tab, providing a second module support rail, the second module support rail including a second tab, coupling the first module support rail and the second module support rail to a torque tube, and providing a solar module having a solar module frame. The solar module frame may define a first tab slot on a first side and a second tab slot on a second side. The method may include aligning one or both of the first tab slot with the first tab of the first module support rail, or the second tab slot with the second tab of the second module support rail, lowering the solar module frame relative to one or both of the first module support rail or the second module support rail, the lowering of the solar module frame causing the first tab to enter the first tab slot and/or causing the second tab to enter the second tab slot, and moving the solar module frame laterally relative to one or both of the first module support rail or the second module support rail to couple the solar module frame to one or both of the first module support rail or the second module support rail, the lateral movement causing the first tab to securely engage the first tab slot and/or causing the second tab to securely engage the second tab slot.

Additionally or alternatively, the first tab slot may include a first deep slot section and a first thin slot section, the second tab slot may include a second deep slot section and a second thin slot section, lowering the solar module frame may cause the first tab to enter the first deep slot section and/or causes the second tab to enter the second deep slot section, and moving the solar module frame laterally causes the first tab to enter the first thin slot section and/or causes the second tab to enter the second thin slot section.

Additionally or alternatively, the first module support rail may include a first portion of a first clinch joint, the solar module frame may include a second portion of the first clinch joint on the first side, the second module support rail may include a first portion of a second clinch joint, the solar module frame may include a second portion of the second clinch joint on the second side, and the method may further comprise coupling the solar module frame to the first module support rail via the first clinch joint and/or coupling the solar module frame to the second module support rail via the second clinch joint.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker;

FIG. 2 is a schematic, top view of a solar tracking system;

FIG. 3 is a schematic, perspective view of a solar tracker in accordance with the disclosure;

FIG. 4 is a schematic, perspective view of a portion of a solar tracker including a solar module and a module support rail in accordance with the disclosure;

FIG. 5A is a schematic, perspective view of the module support rail in accordance with the disclosure;

FIG. 5B is a schematic, front-perspective view of the module support rail, as in FIG. 5A;

FIG. 6A is a schematic, perspective view of a portion of a solar module in accordance with the disclosure;

FIG. 6B is an enlarged view of a slot in a solar module frame, as in Circle 6B in FIG. 6A;

FIG. 6C is a schematic, perspective view of the solar module frame including a reinforcing plate surrounding the slot, as in FIGS. 6A and 6B;

FIG. 6D is a schematic, rear view of a solar module frame slot, as in Box 6 in FIG. 6C;

FIG. 7A is a schematic, perspective view of a tab plate in accordance with the disclosure;

FIG. 7B is a schematic, perspective view of a reinforcement plate in accordance with the disclosure; and

FIGS. 8A to 8E illustrate a method of coupling a solar module frame to a module support rail, in accordance with the disclosure.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar module frames configured to facilitate improved structural stability for solar modules in solar tracking systems. Certain embodiments disclosed herein can improve solar tracking system structural stability while increasing the efficiency of solar module frame installation and reducing costs (e.g., frame and/or support material costs) associated with solar module frames and supports.

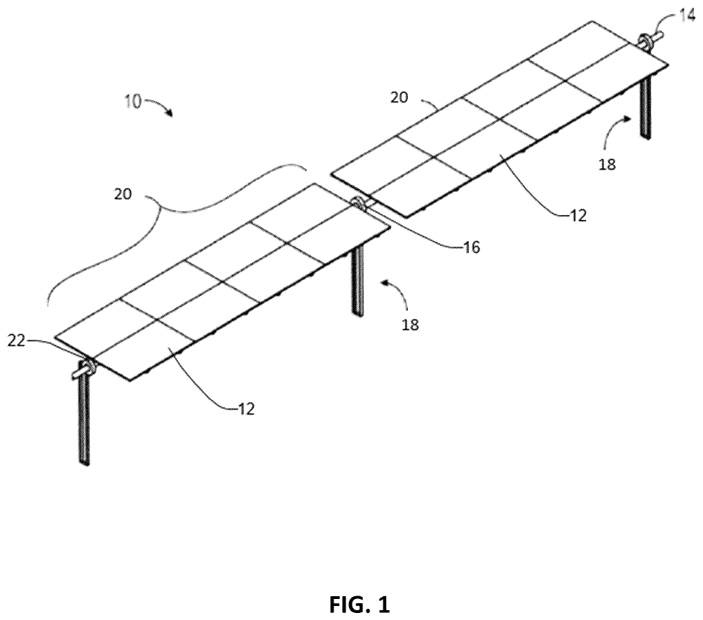

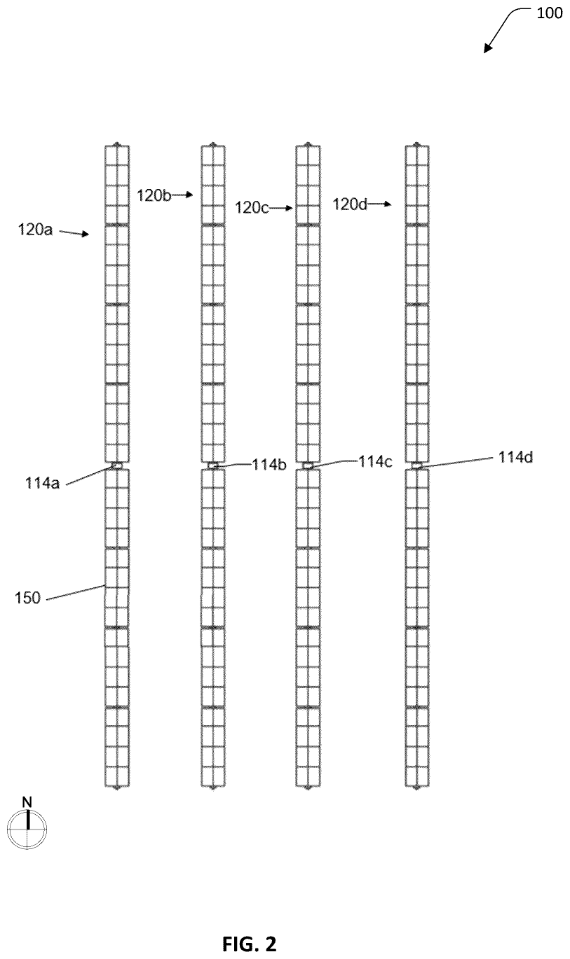

Referring now to the drawings, FIG. 1 illustrates a perspective view of a common arrangement of a solar tracker 10 provided in accordance with the present disclosure. The solar tracker 10 has bays 20 defined by the distance between ground piers 18 (generally referenced herein as piers 18). The solar tracker 10 may be a part of a larger solar tracker system that may include a plurality of solar trackers 10 arranged in rows, an example of which is shown in FIG. 2\, where each row of solar trackers 10 may be referred to as a solar tracker row. FIG. 1 illustrates two bays 20 of the solar tracker 10. However, it will be appreciated that the solar tracker 10 may include four bays, six bays, ten bays, twenty bays, or any other suitable number of bays as desired. At each pier 18 is either a bearing 22 or, as shown in FIG. 1, a drive mechanism 16 shown, for example, near the center of the solar tracker 10. Each of the bearings 22 and the drive mechanism 16 are supported by one of the piers 18. Activation of the drive mechanism 16 rotates a torque tube 14 about an axis of rotation and thus rotates one or more solar modules 12 mounted to the torque tube 14 such that the solar modules 12 can be oriented to a desired position. That desired position may be a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piers 18 is reduced or substantially eliminated and to absorb torsional loads applied to the torque tube 14 by wind loading. In addition, since there may be just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. The solar module assemblies 150 may each include edge protection against hail damage, as described further herein. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

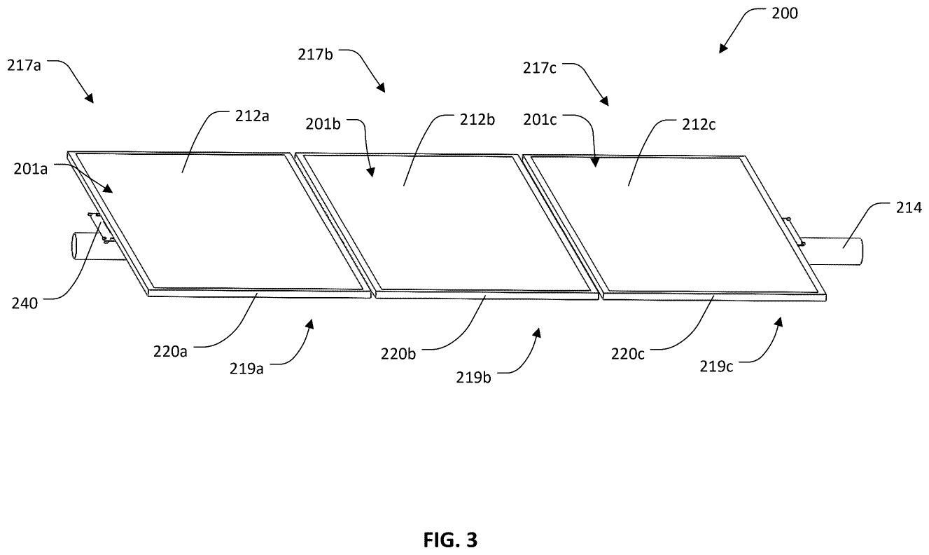

FIG. 3 is a schematic, perspective view of a solar tracker 200 in accordance with the disclosure. The solar tracker 200 may be an example of the solar tracker 10, as in FIG. 1. The solar tracker 200 may include a plurality of solar modules including a first solar module 212a, a second solar module 212b, and a third solar module 212c, generally referred to herein as plurality of solar modules 212. While it is shown that there are three solar modules, it may be contemplated that there may be six solar modules, eight solar modules, twenty solar modules, fifty solar modules, one hundred solar modules, or any other suitable number of solar modules, as desired. The first solar module 212a, the second solar module 212b, and the third solar module 212c may each include a solar module frame 220a, 220b, 220c, respectively. The solar module frames 220a, 220b, 220c may generally be referred to herein as a plurality of solar module frames 220. Each of the plurality of solar modules 212 may be coupled to a torque tube 214 via a plurality of module support rails 240, described further with reference to FIG. 3B. Each one of the plurality of solar modules 212 may include a first end 217 (217a, 217b, 217c) and a second end 219 (219a, 219b, 219c). It will be appreciated that the description of the solar tracker 10 with reference to FIG. 1, further applies to the solar tracker 200.

Each one of the plurality of solar module frames 220 may have a top side 201 (201a, 201b, 201c) and a bottom side opposite the top side 201. The top side 201 of the plurality of solar module frames 220 can bound photovoltaic cells (e.g., photovoltaic cells included at a silicon laminate) and the bottom side of the plurality of solar module frames 220 can be configured to face the torque tube 214. In some examples, the plurality of solar module frames 220 can be a steel frame having a 1.2 mm thickness.

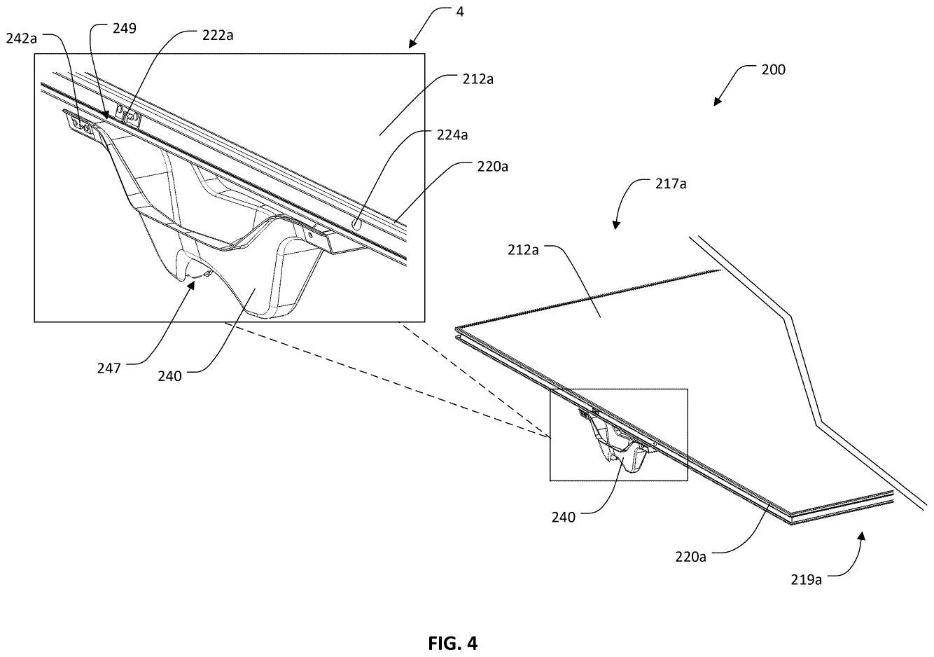

FIG. 4 is a schematic, perspective view of a portion of the solar tracker 200 including the first solar module 212a and the module support rail 240. FIG. 4 illustrates that the module support rail 240 may be configured to receive one or more of the plurality of solar module frames 220 and to couple to the torque tube 214 such that the module support rail 240 may be configured to couple one or more of the plurality of solar module frames 220 to the torque tube 214. The illustrated embodiment shows the module support rail 240 may configured to be coupled to two of the plurality of solar module frames 220. As seen in Box 4 of FIG. 4, the module support rail 240 may have a lower portion 247 that interfaces (e.g., contacts) the torque tube 214 and an opposite upper portion 249 that interfaces with one or more of the plurality of solar module frames 220. The lower portion 247 of the module support rail 240 may have a profile that matches a cross-section of the torque tube 214, which in the illustrated example the torque tube 214 has a rounded (e.g., circular) cross-section and the lower portion 247 of the module support rail 240 defines a semi-circular recessed cutout.

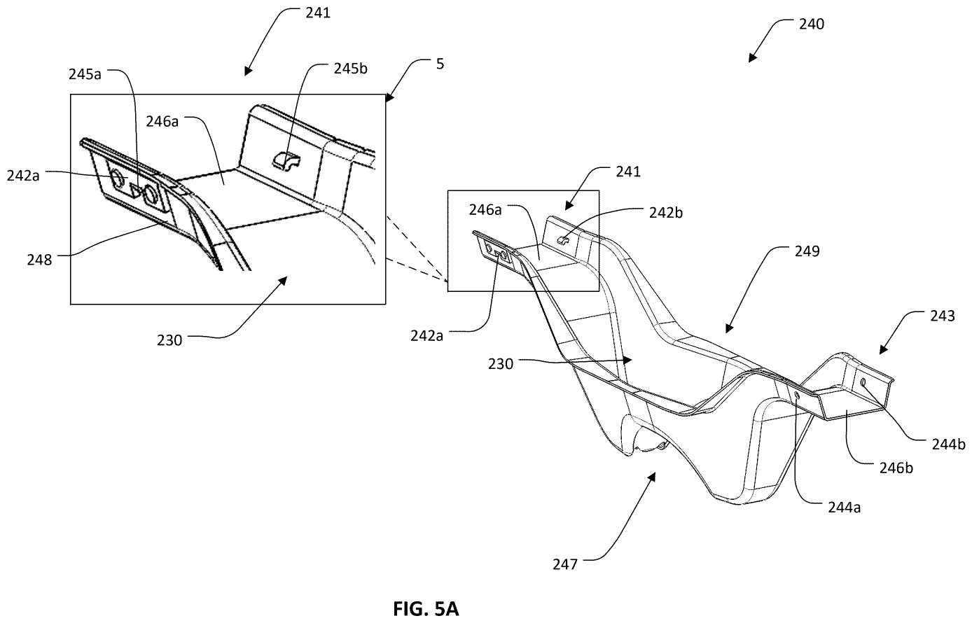

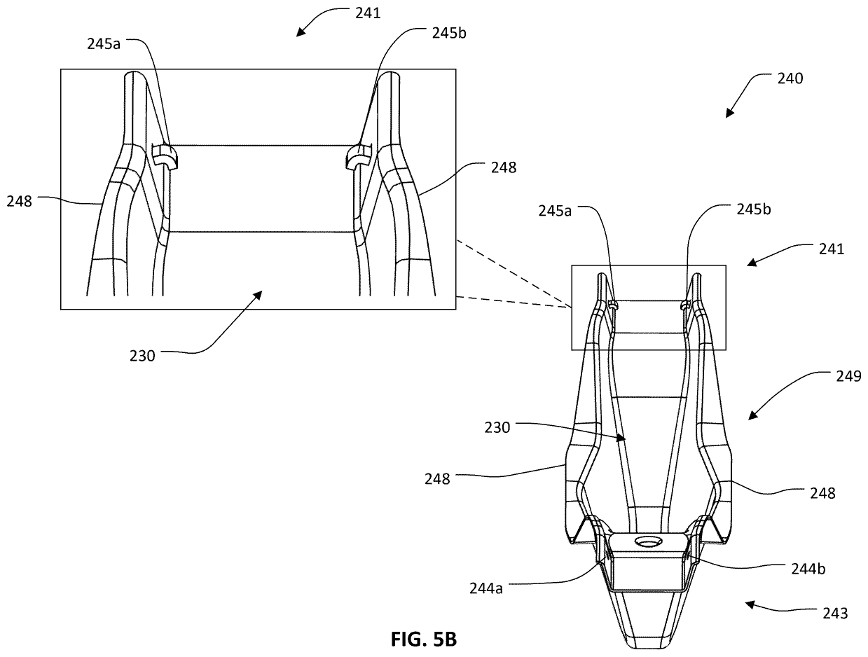

FIG. 5A is a schematic, perspective view of the module support rail 240 in accordance with the disclosure, and FIG. 5B is a schematic, front-perspective view of the module support rail 240. The module support rail 240 may be configured to couple to one or more of the plurality of solar module frames 220 and to couple to the torque tube 214 such that the module support rail 240 may be configured to couple one or more of the plurality of solar module frames 220 to the torque tube 214. The illustrated embodiment shows the module support rail 240 may configured to be coupled to two of the plurality of solar module frames 220.

The module support rail 240 may include a first end portion 241 and an opposite second end portion 243. The first end portion 241 and the second end portion 243 may each include a flattened portion 246a, 246b, respectively, that are configured to contact and support the one or more of the plurality of solar module frames 220. The module support rail 240 may include one or more sidewalls 248. The module support rail 240 may further define a channel 230 between the one or more sidewalls 248.

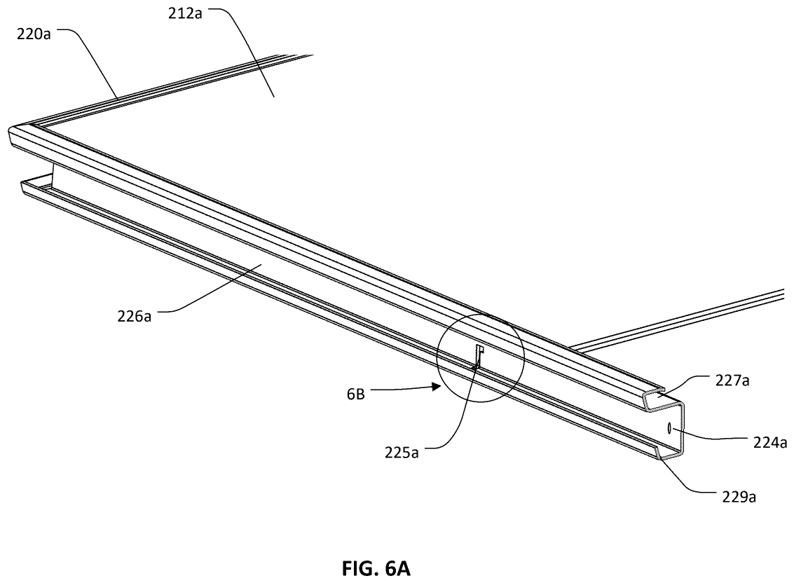

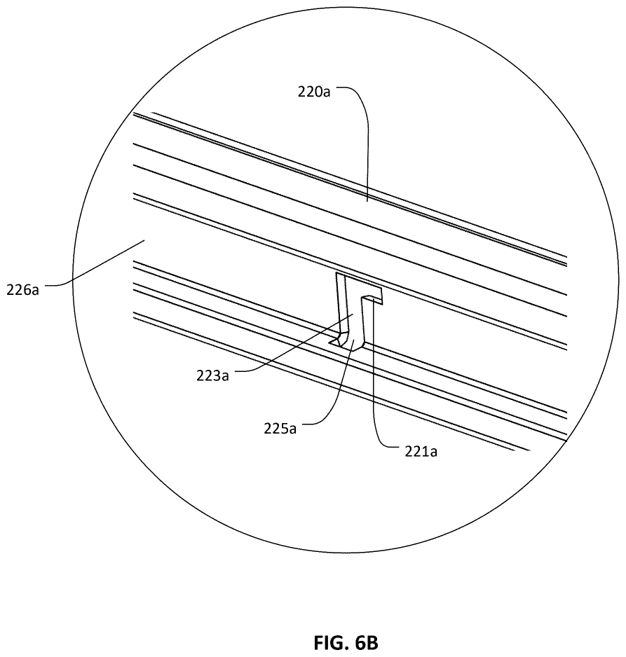

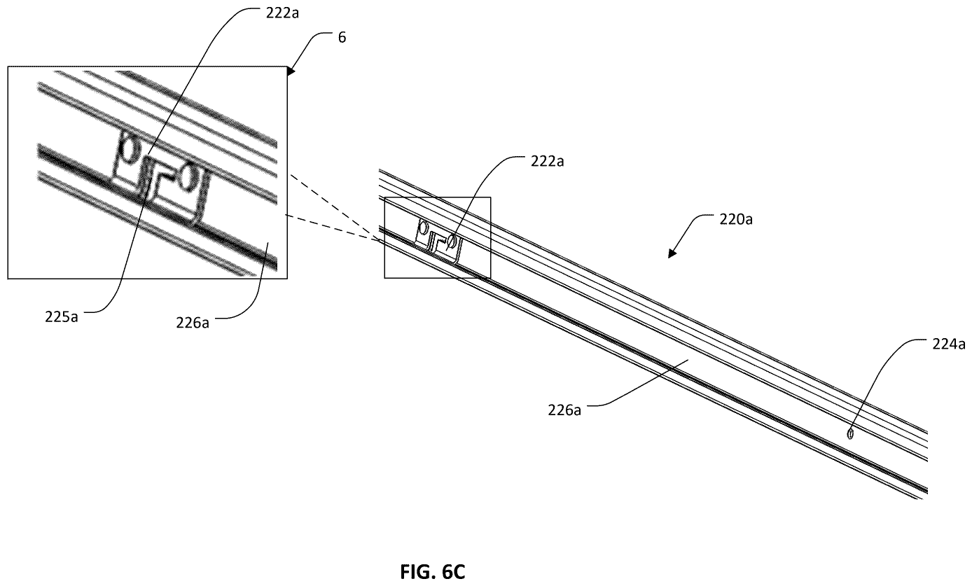

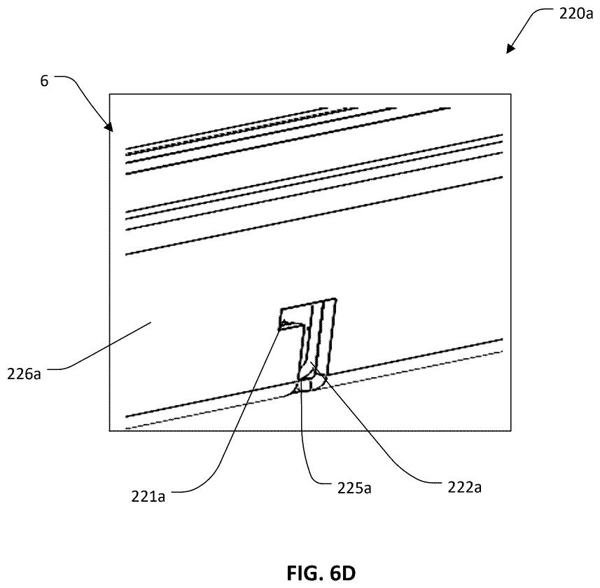

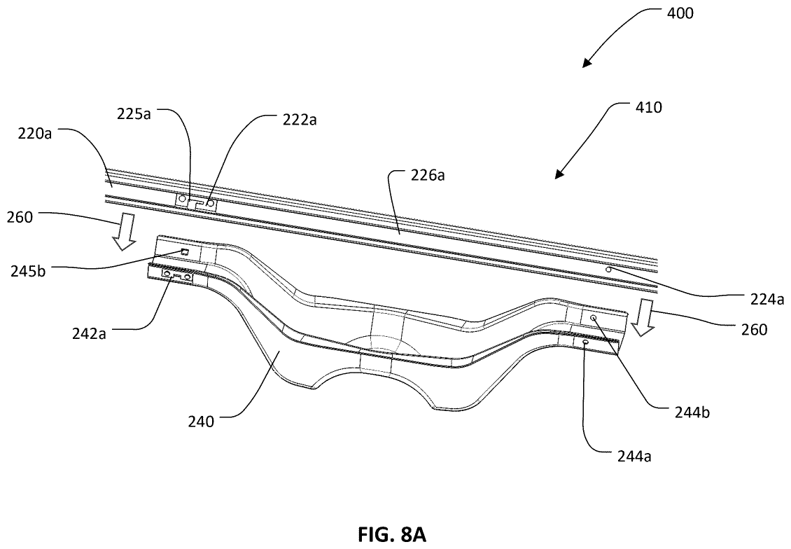

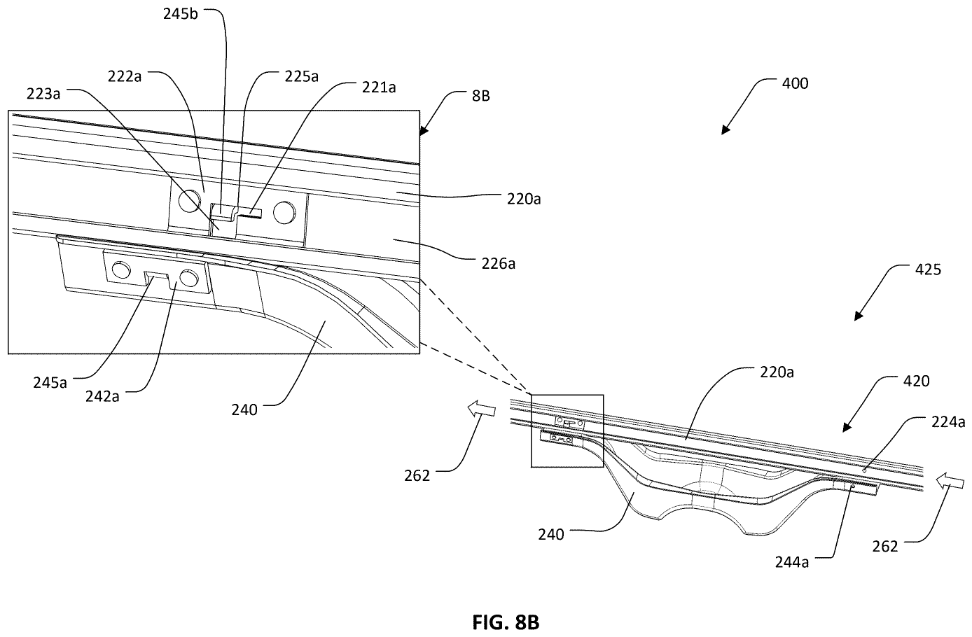

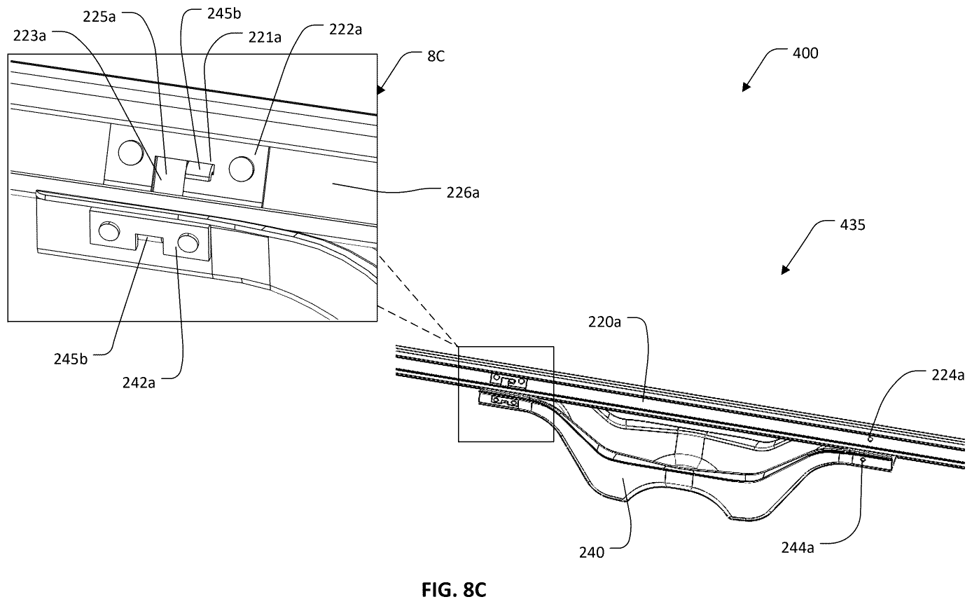

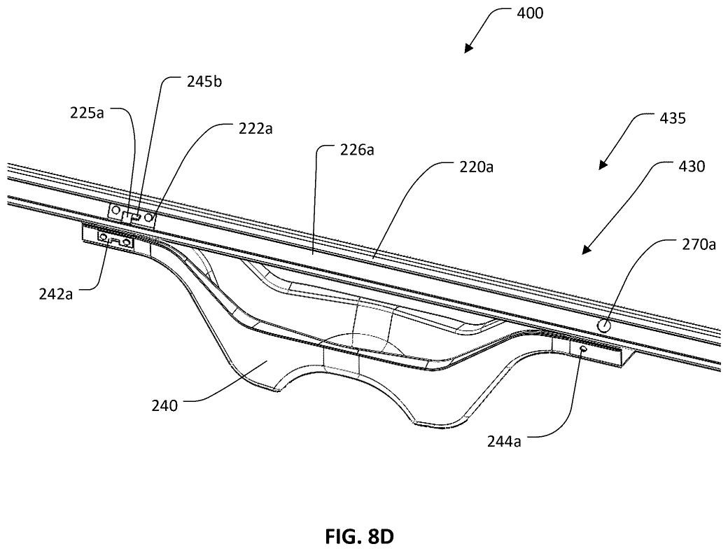

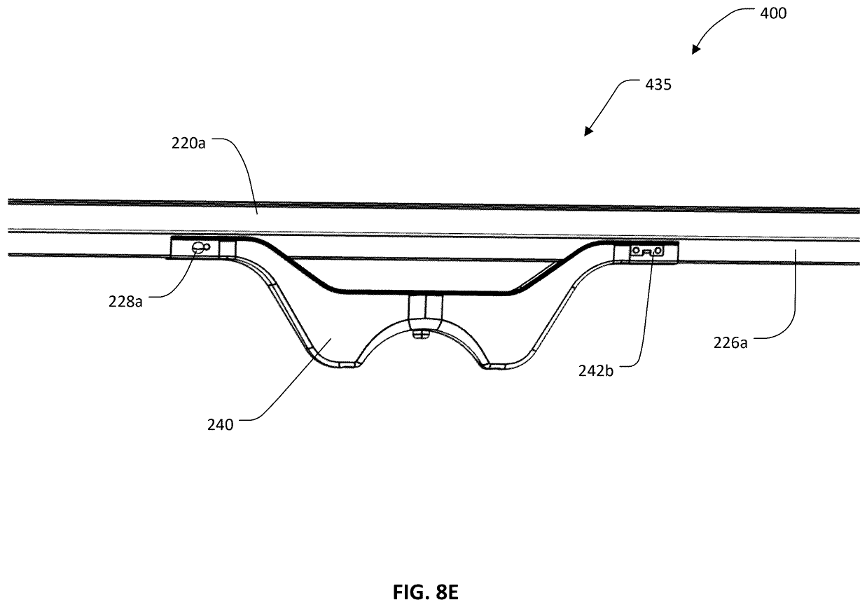

The first end portion 241 may include one or more tabs 245. The one or more tabs 245 may include a first tab 245a and a second tab 245b. The one or more tabs 245 may be configured to engage with one or more tab slots 225 set into each one of the plurality of solar module frames 220. The one or more tab slots 225 will be described further, with reference to FIGS. 6A to 6D. The one or more tabs 245 may be incorporated into, or formed from, one or more tab reinforcement plates 242 such that the one or more tabs 245 and the respective one of the one or more tab reinforcement plates 242 comprise a singular component. The one or more tab reinforcement plates 242 may include a first tab reinforcement plate 242a and a second tab reinforcement plate 242b (shown in FIG. 8E). In some examples, the first tab 245a may be incorporated into, or formed from, the first tab reinforcement plate 242a, and the second tab 245b may be incorporated into, or formed from, the second tab reinforcement plate 242b. Each of the one or more tabs 245 may be inserted through a slot on the module support rail 240, although the slot is not explicitly shown. The corresponding one of the one or more tab reinforcement plates 242 may then be clinched or fastened to a rail sidewall 248. The addition of the one or more tab reinforcement plates 242 increases the thickness of the sidewall 248 of the module support rail 240, thereby increasing the strength of the module support rail 240 at the sidewall 248, without increasing the thickness, and thereby cost, of the entirety of the module support rail 240.

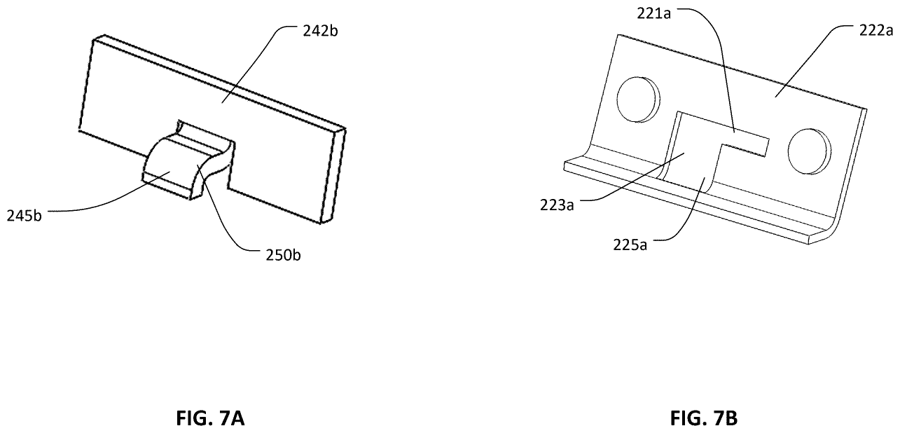

In some examples, as illustrated herein, the one or more tabs 245 may include a bend (e.g., bend 250b in FIG. 7A) that may be configured to engage with each of the plurality of solar module frames 220 to retain the plurality of solar module frames 220 in its respective position. The bend may be at an angle of around 90-degrees (e.g., +/−15 degrees). In some examples, the bend may be at an angle of less than 90-degrees or greater than 90-degrees. In some examples, the one or more tabs 245 may be formed as part of the module support rail 240 without the addition of a reinforcement plate. In such examples, a portion of the sidewall 248 of the module support rail 240 may be cut and folded over to form the bend in each of the one or more tabs 245.

The second end portion 243 of the module support rail 240 may include one or more holes 244. The one or more holes 244 may include a first hole 244a and a second hole 244b. The one or more holes 244 may be configured to align with respective holes 224 of the plurality of solar module frames 220. Alignment of the one or more holes 244 with the holes 224 of the plurality of solar module frames 220 permits placement of a fastener therethrough. The fastener may be one of: rivets, nuts and bolts, a bobtail fastener, a clinch joint, a flow drill screw, or the like.

While it is shown that the one or more holes 244 are positioned adjacent the second end portion 243 of the module support rail 240 and the one or more tabs 245 are positioned adjacent the first end portion 241 of the module support rail 240, it will be appreciated that the one or more holes 244 may be positioned adjacent the first end portion 241 of the module support rail 240 and the one or more tabs 245 may be positioned adjacent the second end portion 243 of the module support rail 240. In either configuration, it will be appreciated that each module support rail 240 in an entirety of a solar tracker row (e.g., solar tracker row 120) will be uniformly arranged (e.g., all of the one or more tabs 245 will be at the same end portion of each module support rail 240).

FIG. 6A is a schematic, perspective view of a portion of the first solar module 212a, FIG. 6B is an enlarged view of a first tab slot 225a in the first solar module frame 220a, as in Circle 6B in FIG. 6A, FIG. 6C is a perspective view of the first solar module frame 220a including a slot reinforcement plate 222a positioned around the first tab slot 225a, and FIG. 6D is a rear view of the enlarged view of the first tab slot 225a with the slot reinforcement plate 222a, as in Box 6 in FIG. 6C. The first tab slot 225a may be one of the one or more tab slots 225 that may be set into each one of the plurality of solar module frames 220. The first tab slot 225a may be one of the one or more tab slots 225 described elsewhere herein.

The first solar module frame 220a may include a frame side portion 226a. The frame side portion 226a may include the first tab slot 225a and the first hole 244a spaced apart along the length of the frame side portion 226a. In some examples, the frame side portion 226a may be angled at angle complementary to an angle of the sidewall 248 of the module support rail 240. For instance, where the sidewalls 248 at the module support rail 240 may taper inward toward the channel 230 moving along the sidewalls 248 toward the channel 230, the frame side portion 226a may have a corresponding angular orientation to generally flushly move the frame side portion 226a along the respective sidewall 248 at the module support rail 240. In addition to the frame side portion 226a, the first solar module frame 220a may include a photovoltaic laminate receptacle 227a and base portion 229a opposite the receptacle 227a. Thus, frame side portion 226a may be located between the receptacle 227a and the base portion 229a, and frame side portion 226a may be at an angle relative to the base portion 229a (e.g., an angle may range from greater than ninety degrees to less than one hundred and eighty degrees, such as ranging from greater than ninety degrees up to one hundred and twenty degrees).

The first tab slot 225a may be configured to engage with the second tab 245b of the module support rail 240. In some examples, the first tab slot 225a may be considered to be an alignment slot, and the first tab slot 225a and the second tab 245b of the module support rail 240 may be complementary and together be configured to guide correct placement of the first solar module frame 220a in east-west direction at the module support rail 240. The engagement of the first tab slot 225a and the second tab 245b may be useful in both providing for east-west direction alignment between the first solar module frame 220a and the module support rail 240 in an efficient manner that can reduce installation time and reduce a number of fastening connections needing to be made between the first solar module frame 220a and the module support rail 240 once the first solar module frame 220a is landed at the module support rail 240 (e.g., when the second tab 245b is at the first tab slot 225a). For example, engagement of the first tab slot 225a and the second tab 245b may further serve to securely fasten the first solar module frame 220a to the module support rail 240 by the second tab 245b protruding into and through the first tab slot 225a, and sliding into a locked position, as will be discussed further with reference to FIGS. 8A to 8E.

The first hole 224a may be configured to align with the second hole 244b of the one or more holes 244 of the module support rail 240. Alignment of the first hole 224a with the second hole 244b of the module support rail 240 may permit a fastener (e.g., fastener 228a in FIG. 8E) to extend through both the first hole 224a and the second hole 244b to further secure the first solar module frame 220a to the module support rail 240. The fastener may be one of: rivets, nuts and bolts, a bobtail fastener, a flow drill screw, or the like. In some examples, the first solar module frame 220a may not include the first hole 224a but may rather be secured to the module support rail 240 via a clinch joint (e.g., clinch joint 270a in FIG. 8D). In such examples, when a clinch joint is used, no fasteners would be used to secure the first solar module frame 220a to the module support rail 240.

As shown in FIG. 6B, the first tab slot 225a may include a thin slot section 221a and a deep slot section 223a. The deep slot section 223a may include a width and height sufficient to permit the second tab 245b to protrude into and therethrough the first tab slot 225a such that the bent portion of the second tab 245b has passed through the first tab slot 225a. Once the second tab 245b has protruded therethrough, the frame side portion 226a of the first solar module frame 220a may move along the respective sidewall 248 at the module support rail 240 thereby positioning the second tab 245b within the thin slot section 221a and locking the first solar module frame 220a in position.

In some examples, as shown in FIGS. 6C and 6D, the first tab slot 225a may further include the slot reinforcement plate 222a. The slot reinforcement plate 222a may be positioned around the first tab slot 225a and may provide added strength to the frame side portion 226a of the solar module frame 220a at the first tab slot 225a. The slot reinforcement plate 222a may be coupled to the frame side portion 226a via one or more fasteners, such as, rivets, nuts and bolts, a bobtail fastener, a clinch joint, a flow drill screw, or the like. The slot reinforcement plate 222a may provide added strength by increasing the thickness of the frame side portion 226a of the first solar module frame 220a, without increasing the thickness, and thereby cost, of the entirety of the first solar module frame 220a.

FIG. 7A is an enlarged, perspective view of the second tab reinforcement plate 242b. The second tab reinforcement plate 242b may be an example of the one or more tab reinforcement plates 242 described herein. As discussed elsewhere herein, the second tab 245b may be incorporated into, or formed from, the second tab reinforcement plate 242b. The second tab reinforcement plate 242b may be clinched or fastened (e.g., via a fastener) to the rail sidewall 248. The addition of the one or more tab reinforcement plates 242 increases the thickness of the sidewall 248 of the module support rail 240, thereby increasing the strength of the module support rail 240 at the sidewall 248, without increasing the thickness, and thereby cost, of the entirety of the module support rail 240. The thickness of the sidewall 248 of the module support rail 240 without the one or more tab reinforcement plates 242 may be in a range of about 1.2 mm (millimeters) to about 1.5 mm. The thickness of the one or more tab reinforcement plates 242 may be in a range of about 2 mm (millimeters) to about 2.5 mm. Thus, the thickness of the sidewall 248 of the module support rail 240 and the one or more tab reinforcement plates 242 may increase to a range of about 3.2 mm to about 4 mm.

In some examples, as illustrated herein, the second tab 245b may include a bend 250b that may be configured to engage with the first tab slot 225a of the first solar module frame 220a to retain the first solar module frame 220a in its respective position at the module support rail 240.

FIG. 7B is an enlarged, perspective view of the slot reinforcement plate 222a. As discussed elsewhere herein, the slot reinforcement plate 222a may be positioned around the first tab slot 225a and may provide added strength to the frame side portion 226a of the solar module frame 220a at the first tab slot 225a. The slot reinforcement plate 222a may be coupled to the frame side portion 226a via one or more fasteners, such as, nuts and bolts, a bobtail fastener, a clinch joint, a flow drill screw, or the like. The slot reinforcement plate 222a may provide added strength by increasing the thickness of the frame side portion 226a of the first solar module frame 220a, without increasing the thickness, and thereby cost, of the entirety of the first solar module frame 220a. The thickness of the sidewall 248 of the module support rail 240 without the one or more slot reinforcement plates 222 may be in a range of about 1.2 mm (millimeters) to about 1.5 mm. The thickness of the one or more slot reinforcement plates 222 may be in a range of about 2 mm (millimeters) to about 2.5 mm. Thus, the thickness of the sidewall 248 of the module support rail 240 and the one or more slot reinforcement plates 222 may increase to a range of about 3.2 mm to about 4 mm.

FIGS. 8A to 8E illustrate a method 400 of coupling the first solar module frame 220a to the module support rail 240, in accordance with the disclosure. While FIGS. 8A to 8E illustrate coupling the first solar module frame 220a to the module support rail 240, it will be appreciated that the method 400 may be utilized for coupling each of the plurality of solar module frames 220 to any module support rail 240 positioned along the length of the torque tube 214. The first solar module frame 220a and the module support rail 240 are simply used for illustration purposes.

At step one 410, as shown in FIG. 8A, the first solar module frame 220a, and thereby the first solar module 212a, may be positioned above the module support rail 240. The deep slot section 223a of the first tab slot 225a of the first solar module frame 220a may be lined up above the second tab 245b on the module support rail 240. The first solar module frame 220a may then be lowered onto the module support rail 240, as indicated by arrows 260. As such, the second tab 245b may pass into the first tab slot 225a as the first solar module frame 220a lands onto the module support rail 240, as shown in further detail in Box 8B in FIG. 8B. When the second tab 245b is positioned within the deep slot section 223a, as shown in Box 8B, the first solar module frame 220a may be considered to be in an unlocked position 425. In the unlocked position 425, the first hole 224a may not be fully aligned with the second hole 244b of the module support rail 240, thereby preventing a fastener 228a (FIG. 8E) from being positioned therethrough.

Step two 420, as shown in FIG. 8B, may include sliding the first solar module frame 220a along the respective sidewall 248 at the module support rail 240, as indicated by arrows 262, thereby fully engaging the second tab 245b with the thin slot section 221a and locking the first solar module frame 220a in a locked position 435, as shown in further detail in Box 8C in FIG. 8C. In the locked position 435, the first hole 224a may be fully aligned with the second hole 244b of the module support rail 240, thereby permitting placement of a fastener 228a (FIG. 8E) therethrough. In some examples, a clinch joint 270a may be used to secure the first solar module frame 220a to the module support rail 240, as illustrated at step three 430 in FIG. 8D. In some examples, the first solar module frame 220a may be coupled to the module support rail 240 via the fastener 228a, as shown in FIG. 8E.

When the first solar module frame 220a and the module support rail 240 are in the locked position 435, as shown in FIGS. 8D and 8E, a wind load that may be exerted upon the first solar module 212a may be transferred to the second tab 245b as the wind pushes up on the first solar module 212a. When the wind load pushes down on the first solar module 212a, the wind load will be transferred to the module support rail 240.

While the Figures herein make reference to the first solar module frame 220a, the module support rail 240, and respective components thereof, it will be appreciated that the description of the first solar module frame 220a, the module support rail 240, and respective components thereof may further apply to each of the plurality of solar module frames 220, any module support rail 240 along the length of the torque tube 214, and any respective components thereof (e.g., tabs, slots, slot reinforcement plates, tab reinforcement plates, etc.). The first solar module frame 220a, the module support rail 240, and respective components thereof, are simply used for illustration purposes.

The example solar module frames (220) and the components thereof described herein may be formed from a sheet metal, such as a steel sheet. In some examples, the solar module frames (220) and the components thereof may be formed from aluminum, such as by extruding aluminum. In some examples, the solar module frames (220) and the components thereof may be formed from titanium, stainless steel, nickel alloys, platinum, or the like. The solar module frames (220) and the components thereof may be formed by bending with bends or folds to form the desired profile.

Various non-limiting exemplary embodiments have been described. It will be appreciated that suitable alternatives are possible without departing from the scope of the examples described herein.

1. A mounting system for mounting one or more solar modules to a torque tube, the mounting system comprising:
a module support rail having a lower portion couplable to a torque tube and an upper portion, the upper portion of the module support rail comprising:
a first end portion including a first tab;
a second end portion defining a first hole configured to accept a first fastener;
a first solar module coupled with a first solar module frame, the first solar module frame defining:
a first tab slot sized and shaped to accept the first tab to couple the first solar module frame to the module support rail; and
a first hole spaced apart from the first tab slot along a length of the first solar module frame, the first hole of the first solar module frame configured to align with the first hole of the module support rail and to accept the first fastener to further couple the first solar module frame to the module support rail.

2. The mounting system of claim 1, further comprising a slot reinforcement plate coupled to the first solar module frame proximate the first tab slot.

3. The mounting system of claim 2, wherein the slot reinforcement plate defines a third tab slot, the third tab slot approximately the same size and shape of the first tab slot.

4. The mounting system of claim 1, wherein the module support rail includes a tab reinforcement plate coupled with the first tab.

5. The mounting system of claim 4, wherein the tab reinforcement plate is integrated with the first tab into a singular component.

6. The mounting system of claim 1, wherein the first tab slot includes a thin slot section and a deep slot section, the thin slot section sized and shaped to lock the first solar module frame to the module support rail in a position.

7. The mounting system of claim 6, wherein a height of the thin slot section is less than a height of the deep slot section but greater than a thickness of the first tab.

8. The mounting system of claim 1, wherein the first tab has a first tab width; and
wherein the first tab slot includes a deep slot section defined by the first solar module frame, the deep slot section having a slot width sufficiently larger than the first tab width to enable the first tab to be inserted into the first tab slot.

9. The mounting system of claim 1, wherein the first tab includes one or more bends, the one or more bends of the first tab configured to prevent the first tab from decoupling from the first tab slot of the first solar module frame.

10. The mounting system of claim 9, wherein the one or more bends include a bend of around 90 degrees.

11. The mounting system of claim 1, wherein the first end portion of the module support rail further includes a second tab; and
wherein the second end portion of the module support rail further defines a second hole configured to accept a second fastener.

12. The mounting system of claim 11, further comprising:
a second solar module coupled with a second solar module frame, the second solar module frame defining:
a second tab slot sized and shaped to accept the second tab to couple the second solar module frame to the module support rail; and
a second hole spaced apart from the second tab slot along a length of the second solar module frame, the second hole of the second solar module frame configured align with the second hole of the module support rail and to accept the second fastener to further couple the second solar module frame to the module support rail.

13. A mounting system for mounting a solar module to a torque tube, the mounting system comprising:
a first module support rail couplable to a torque tube, the first module support rail comprising:
a first end portion including a first tab;
a second end portion defining a first hole configured to accept a first fastener;
a second module support rail couplable to the torque tube, the second module support rail comprising:
a first end portion including a second tab;
a second end portion defining a second hole configured to accept a second fastener; and
a solar module coupled with a solar module frame, the solar module frame defining:
a first tab slot sized and shaped to accept the first tab on a first side of the solar module frame;
a second tab slot sized and shaped to accept the second tab on a second side of the solar module frame;
a first hole spaced apart from the first tab slot along a length of the first side of the solar module frame, the first hole of the solar module frame configured align with the first hole of the first module support rail and to accept the first fastener to couple the solar module frame to the first module support rail; and
a second hole spaced apart from the second tab slot along a length of the second side of the solar module frame, the second hole of the solar module frame configured align with the second hole of the second module support rail and to accept the second fastener to couple the solar module frame to the second module support rail.

14. The mounting system of claim 13, wherein the solar module frame has an approximately consistent thickness on its first side and its second side.

15. The mounting system of claim 14, further comprising a first tab slot reinforcement plate secured proximate the first tab slot and a second tab slot reinforcement plate secured proximate the second tab slot, the first tab slot reinforcement plate and the second tab slot reinforcement plate increasing an overall thickness between an interior surface and an exterior surface of the solar module frame at the respective tab slot.

16. The mounting system of claim 15, wherein the first tab slot reinforcement plate and the second tab slot reinforcement plate have thicknesses greater than the thickness of the solar module frame.

17. The mounting system of claim 13, wherein a thickness of the solar module frame is in the range of about 1.2 millimeters to 1.5 millimeters.

18. A method of mounting a solar module to a torque tube, the method comprising:
providing a first module support rail, the first module support rail including a first tab;
providing a second module support rail, the second module support rail including a second tab;
coupling the first module support rail and the second module support rail to a torque tube;
providing a solar module having a solar module frame, the solar module frame defining:
a first tab slot on a first side;
a second tab slot on a second side;
aligning one or both of the first tab slot with the first tab of the first module support rail, or the second tab slot with the second tab of the second module support rail;
lowering the solar module frame relative to one or both of the first module support rail or the second module support rail, the lowering of the solar module frame causing the first tab to enter the first tab slot and/or causing the second tab to enter the second tab slot; and
moving the solar module frame laterally relative to one or both of the first module support rail or the second module support rail to couple the solar module frame to one or both of the first module support rail or the second module support rail, the lateral movement causing the first tab to securely engage the first tab slot and/or causing the second tab to securely engage the second tab slot.

19. The method of claim 18, wherein:
the first tab slot includes a first deep slot section and a first thin slot section;
the second tab slot includes a second deep slot section and a second thin slot section;
lowering the solar module frame causes the first tab to enter the first deep slot section and/or causes the second tab to enter the second deep slot section; and
moving the solar module frame laterally causes the first tab to enter the first thin slot section and/or causes the second tab to enter the second thin slot section.

20. The method of claim 18, wherein:
the first module support rail includes a first portion of a first clinch joint;
the solar module frame includes a second portion of the first clinch joint on the first side;
the second module support rail includes a first portion of a second clinch joint;
the solar module frame includes a second portion of the second clinch joint on the second side;
and
the method further comprises coupling the solar module frame to the first module support rail via the first clinch joint and/or coupling the solar module frame to the second module support rail via the second clinch joint.
